(19) United States
(12) Patent Application Publication
(10) Pub. No.: US 2006/0041546 A1
(43) Pub. Date: Feb. 23, 2006

(54) Consulting system using network, content making method and recording medium for storing a program to perform the system and method

(76) Inventor: Ki Soon Ahn, Seoul (KR)

Correspondence Address: MERCHANT & GOULD PC, P.O. BOX 2903, MINNEAPOLIS, MN, 55402-0903, US

(21) Appl. No.: 10/521,885

(22) PCT Filed: Jul. 18, 2003
(86) PCT No.: PCT/KR03/01426

§ 371 Date: Jan. 18, 2005

(30) Foreign Application Priority Data
Jul. 18, 2002 (KR) 10-2002-0041873

(51) Int. Cl. G06F 17/30

(52) U.S. Cl. 707/5

(57) ABSTRACT

The present invention discloses a consulting system using network, a content making method and a recording medium for storing a program to perform the system and method. While a user replies questions given in a system, a consulting system using network supplies personalized final answers. The consulting system using network is configured by producing contents to obtain personalized final answers using objects (problem, unit and help) having property. Accordingly, the consulting system which allows on-line consultation on expert fields is provided on the Web, and personalized answers are also provided.

### TECHNICAL FIELD

The present invention relates to a consulting system using network, a content making method and a recording medium for storing a program to perform the system and method. More specifically, the present invention relates to a consulting system using network which supplies personalized final answers while a user replies questions given in a system, a method for configuring a consulting system using network by producing contents to obtain personalized final answers using objects (problem, unit and help) having property, and a recording medium for storing a program to perform the system and method.

### BACKGROUND ART

In general, services in law, tax business and medical care are provided by human experts such as lawyers, tax accountants or doctors having expertise,

However, when clients intend to consult with experts of the above-described fields, the clients have to pay considerable service charge for the consultation.

Due to recent development of wire/wireless network and internet-related technologies, on-line consulting service using network such as internet has been developed in various fields.

However, it is difficult to provide sufficient consultation or service to the above-described expert fields using network.

In the consulting system using network on the above-described fields, it is difficult to perform a database operation on rules by cases in a corresponding field. It is also difficult for program developers to embody algorithm with understanding related to expert fields. Additionally, it is difficult to optimize answers for consultation of cases in view of various conditions.

Here, the consulting system using network refers to a system where a user consults, supports or execute corresponding service as proxy using, computers without help of experts in specific fields.

Accordingly, in the consulting system using network on law, tax business and medical care, tools should be provided by experts in order that rules by cases may be easily made into database. It is preferable that these tools should be made directly by experts to embody algorithm suitable for case types. In the above embodiment process, experts should make tools to derive optimized answers in view of various conditions.

However, the currently provided tools for configuring a consulting system using network do not enable users to obtain database, algorithm and answers corresponding to consultation by cases of expert fields.

Conventionally, the environment for developing a consulting system using network depends on programmers who do not sufficiently understand information on expert fields. It is difficult for such programmers to make rules by complicated cases into database, and to derive optimum answers in the consulting system.

As a result, it is difficult to embody a consulting system using network for on-line consultation in expert fields via network such as internet.

### DETAILED DESCRIPTION OF THE INVENTION

Accordingly, it is an object of the present invention to embody a consulting system using network for providing a consulting function on expert fields via network and for providing personalized answers through an interactive process where a user answers questions given in the system based on conditions.

It is another object of the present invention to embody database and algorithm for consultation while an expert of a specific expert generates objects using formalized tools, and to embody personalized answers provided to a user depending on rules.

It is still another object of the present invention to embody algorithm for providing personalized answer's depending on rules obtained by classifying objects by an expert of a specific field.

In order to achieve the above objects, there is provided a consulting system using network which provides consulting service of a specific field to a user. The consulting system comprises a database system and a service component. The database system comprises a first object (Problem) having questions given to the user and answers selected by the user, and a second object (Unit) having a series of processes and having answer script for reflecting the process results, wherein rules between the objects are defined depending on corresponding property of the objects. The service component provides an interface screen for the consulting service to the user via the network, performs a process where the user answers the questions supplied by the rules, and supplies personalized final answers to the user by performing the answer script as the process result.

Preferably, the service component comprises protocol for providing contents to at least one or more equipments selected from personal computer accessible to the network, PDA (Personal Digital Assistant), wireless terminal, wire/wireless telephone set and internet phone.

In an embodiment, there is provided a recording medium for storing a program by using a database system comprising a first object (Problem) having questions given to the user and answers selected by the user, and a second object (Unit) having a series of processes and having answer script for reflecting the process results wherein rules between the objects are defined depending on corresponding property of the objects. The above program is performed by the following steps:

the first step where questions resulting from the process performed by the rules are provided to the user interfaced via the network and the user answers the questions; and

the second step of providing final answers to the user by performing the answer script as a result of the first step.

In an embodiment, there is provided a content making method to embody a consulting system for providing consulting service of a specific field to a user connected via network. The above content making method comprises:

the first step of generating a plurality of first objects (Problem) having properties to set minimum implementation conditions, questions given to the user and answers selected by the user; and

the second step of defining a series of processes including the first object (Problem) with another first object (Problem) and/or another second object (Unit), and of defining answer script for representing final answers given to the user as a result of the process, thereby generating the second object (Unit).

As a compulsory condition for applying the first object to the second object is defined as a property of the second object prior to the implementation condition of the first object, the compulsory condition preferably precedes the implementation condition of the first object during the process of implementing contents set in the second object.

Also, a property hidden to the user may be provided to the first object (Problem).

In an embodiment, there is provided a recording medium to embody a consulting system for providing consulting service of a specific field to a user connected via network. The recording medium for storing a program is performed by the following steps:

the first step of generating a plurality of first objects (Problem) having properties to set minimum implementation conditions, questions given to the user and answers selected by the user; and

the second step of defining a series of processes including the first object (Problem) with another first object (Problem) and/or another second object (Unit), and of defining answer script for representing final answers given to the user as a result of the process, thereby generating the second object (Unit).

In an embodiment, there is provided a consulting system using network wherein a plurality of objects have a rule of interconnection based on conditions, wherein the plurality of objects have a tree structure depending on the rules. The consulting system comprises:

the first step of providing questions corresponding to a specific object to a user connected via network; and

the second step where the user answers the questions.

In the above process, a next object having the tree structure is determined up to down depending on the answers, and the first step and the second step are repeatedly performed to embody the interactive consultation with the user.

### BRIEF DESCRIPTION OF THE DRAWINGS

FIG. 1 is a block diagram illustrating an example of a consulting system using network and a content making method thereof according to an embodiment of the present invention.

FIG. 2 is a diagram illustrating the relationship between upper units and lower units according to an embodiment of the present invention.

FIGS. 3 to 7 are diagrams illustrating examples of an interface screen for making contents.

FIG. 8 is a flowing chart for providing final answers of an example of Table 2.

### PREFERRED EMBODIMENTS OF THE INVENTION

The present invention relates to an on-line consulting system via network, and a method to embody the system. The network includes wire network, wireless network and the Internet. Equipment such as personal computer accessible to the network, PDA (Personal Digital Assistant), wireless terminal, wire/wireless telephone set and internet phone may be used for contents. On-line technologies include universally bilateral communicatable technologies

In a consulting system using network according to an embodiment of the present invention, a user(non-expert) obtains personalized final answers as the user answers contents shown in an interface screen provided sequentially.

A user can use the consulting system using network mounted on an accessible server by wire or wireless via web (internet) or wire/wireless network by using personal computer, mobile phone, PDA or telephone set.

Tools for performing a method of making a consulting system using network may provide interface suitable for various access methods. However, since contents are generally produced in personal computer, interface suitable for the contents is presented as an embodiment of the present invention.

In an embodiment of the present invention, a consulting system using network comprises database and algorithm for consultation of expert fields such as law, tax business and medical care. The above database and algorithm can be embodied by content making tools of the consulting system using network. The content making tools are used by experts to make contents.

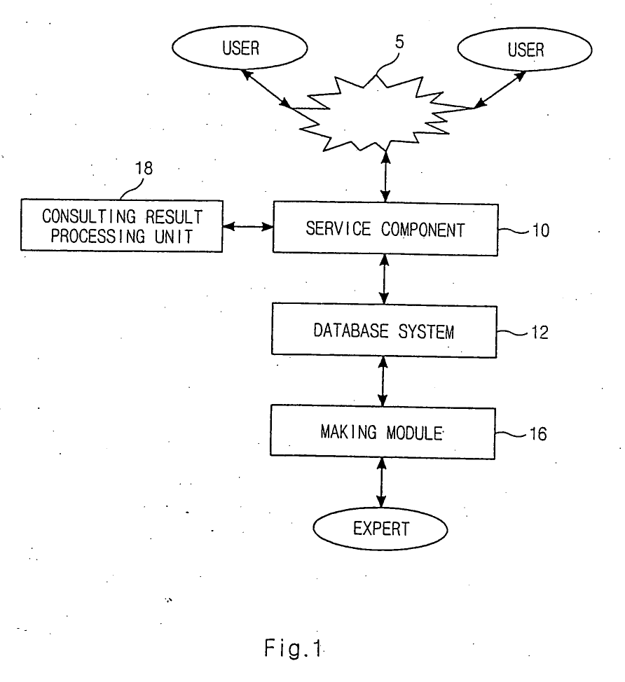

Referring to FIG. 1, a user (non-expert) connects with a network 5 on line. A service component 10 for providing an interface screen to a user via the network 5 is comprised.

15. The service component 10 provides a connection screen having a standardized screen for on-line connection. The connection, screen may be provided as types of usable format (HTML, XML, etc.) in equipment used by the user. If the present invention is applied to an ARS system, the service component 10 may comprise protocol for voice service.

The service component 10 provides a connection screen with interworking with a database system 12, supplies questions and answers necessary for consultation to a user who wants consultation, and embodies contents by providing final answers based on the questions and answers. For this process, the service component 10 may be set as a web application program.

The consulting system using network is provided via the network 5 by interworking of the service component 10 with the database system 12.

The database system 12 stores objects for embodying contents and properties on each object.

Here, a consulting result processing unit 18 is further comprised. The service component 10 backs up consulting results by each case into the consulting result processing unit 18. The consulting result processing unit 18 may extract data including solution of consultation and satisfaction as a result of the backup consultation in order to perform a subsequent process (e.g. direct consultation of experts, verification of consultation results, update of consultation).

The consultation contents received in the consulting result processing unit 18, if its function is preset, may be transmitted into a selectively designated expert by predetermined methods (intranet messaging, e-mail, facsimile transmission, short message service SMS). The examination of consulting results or upgrade of answers may be performed by using direct consultation on corresponding contents by experts or by using tools provided by the present invention.

Contents for providing a consulting system using, network according to an embodiment of the present invention embody questions for consultation, answers thereof and final answers. The contents are made by interworking relationship (rule) resulting from definition of objects comprising Problem, Unit and Help. For the convenience of explanation, each object is represented by <Problem>, <Unit> and <Help>.

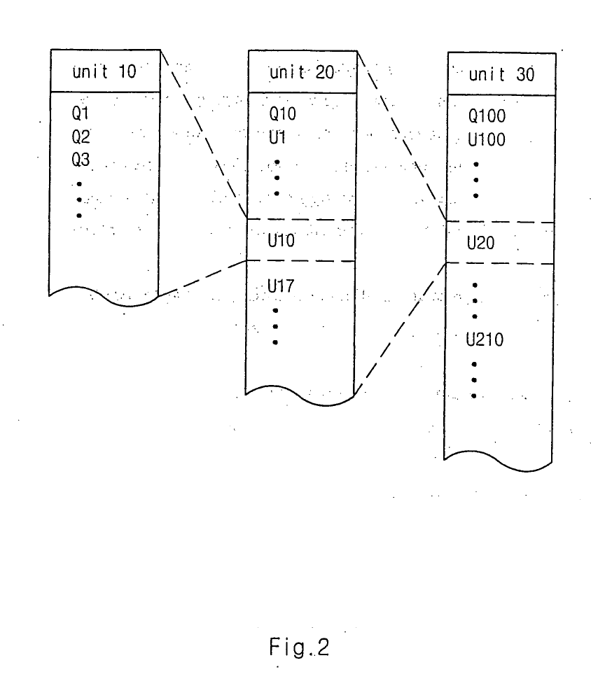

In an embodiment, the objects for embodying the contents are generated by experts using a making module 16. If the objects are applied to the database system 12 by the making module 16, contents for consultation service of expert fields defined by the objects are provided to a user. The making module 16 is a tool which an expert uses in order to store expertise logically and systematically in the database system 12 according to a predetermined method defined by the present invention.

<Unit> of the objects is an element including at least one or more <Problems>. As shown in FIG. 2, one <Unit> may comprise a plurality of <Problems>(e.g. <Unit 10>) or comprise at least one <Problem> and one or more <Units> (e.g. <Unit 20>, <Unit 30>).

Here, <Unit> may be classified into upper or lower ranks depending on inclusion relationship. In FIG. 2, Q1, Q2, Q3, . . . , Q10, Q100 represent <Problem>, and U1, U10, U17, U100, U20 and U210 represent <Unit>. As shown in FIG. 2, <Unit 10> is included in <Unit 20>, and <Unit 20> is included in <Unit 30>. That is, <Unit 30> is the most significant <Unit> in FIG. 2.

Accordingly, <Unit>, which has a series of processes for requiring answers provided to a user, is an object having at least one or more answers corresponding to a result of performing a process for providing service to a user. <Problem> is an object for requiring questions given to a user and answers of a user.

Each object has every property as shown in the following table.

TABLE 1

| Object | Property |
|---|---|
| <Problem> | Code, Alias, Question, Condition, Answer, etc. |
| <Unit> | Code, Alias, Title, Condition, Content, Answer script, etc. |
| <Help> | Code, Alias, Head, Body, etc. |

The property corresponding to each object is defined as follows.

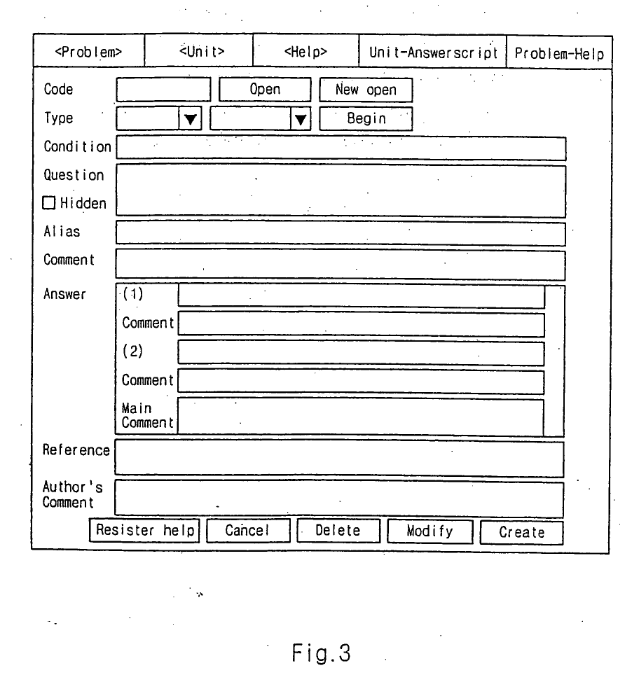

Property of <Problem>: configured on an interface screen of FIG. 3.

“Code”: an identifier for identifying <Problem>

“Alias”: serves as an identifier. a given name so that experts may identify <Problem> easily.

“Type”: determined answer types of <Problem>. “Type” may be provided as various selectable types. In an embodiment of the present invention, the types include “1 of many”, “0, 1 or more of many”, “Yes or No”, “Text”, “Number” and “Date”. “1 of Many” is a type where one answer is selected. “0, 1 or more of many” is a type where no answer is selected or one or more answers are selected. “Yes or No” is a type where one of “Yes” and “No” is selected. “Text” is a type where letters are received. “Number” is a type where figures are received. “Date” is a type where date is received.

Since a plurality of “Answers” may be required when “Type” is “1 of many” or “0, 1 or more of many”, variables for determining the number of answers may be provided on the right side of the screen.

“Condition”: defines conditions where <Problem> is performed. If “Condition” is not defined, <Problem> is performed without condition.

“Question”: questions shown to a user (non-expert).

“Hidden” checked when a type of <Problem> is defined as “Hidden”. <Problem> of “Hidden” type is not shown to a user anytime. <Problem> of “Hidden” type requires an answer itself if the <Problem> is pre-defined as “Condition” is not defined.

“Answer”: presented to a user to select or input answers to questions. The number of answers may be changed corresponding to “Type”.

“Comment” provides explanations on “Answer”, “Question” or <Problem>.

“Reference”: references on which <Problem> is based are described (When a consulting system in a law field using network is presented in an embodiment of the present invention, statutes, precedents or literature are described). “Reference” may be used in a subsequent update.

“Author's Comment” A maker describes contents necessary for making contents.

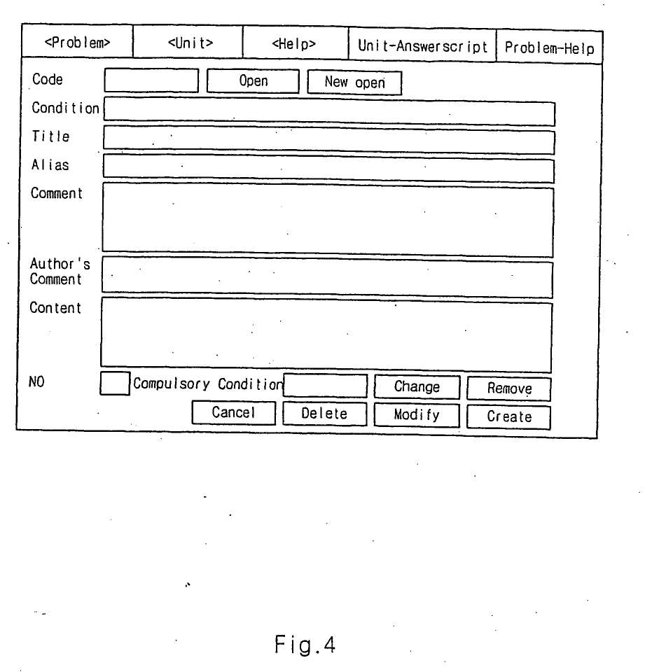

Property of <Unit>: configured on an interface screen of FIG. 4.

“Code” an identifier for identifying <Unit>

“Alias”: serves as an identifier. a given name so that experts may identify contents easily.

“Title”: a title of <Unit>. The title presents briefly what <Unit> relates to.

“Condition”: Condition to perform a corresponding <Unit> on process of a specific upper <Unit> including the corresponding <Unit> as a lower <Unit>.

“Comment”: explanation of a corresponding <Unit> shown to a user.

“Content”: registers <Problems> and lower <Units> consisting of a <Unit>, and determines the sequence.

“Compulsory condition”: applied by designation of <Problem> or lower <Unit> in a specific <Unit>. The designated <Problem> and <Unit> apply “Compulsory condition” applied prior to “Condition” of the <Problem> and <Unit>. The “Compulsory condition” enables re-use of other <Problem> or <Unit> pre-made to be used in other <Units>.

“Author's Comment”: A maker describes contents necessary for making contents.

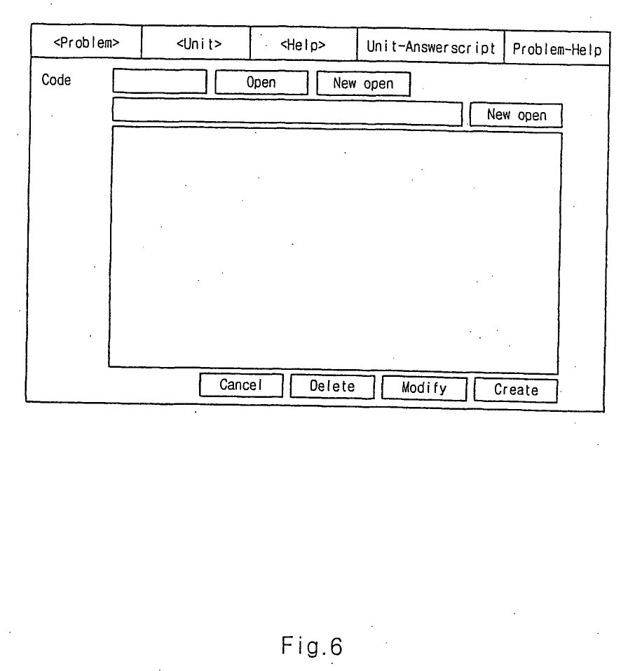

“Answer script”: Answers to a corresponding <Unit> are described according to grammar. Personalized final answers provided in the present invention are provided by “Answer script” of properties of <Unit>. Although an embodiment is provided by an interface screen of FIG. 6 for the convenience of preparation, the embodiment may be included as a property in the interface screen of <Unit> of FIG. 4.

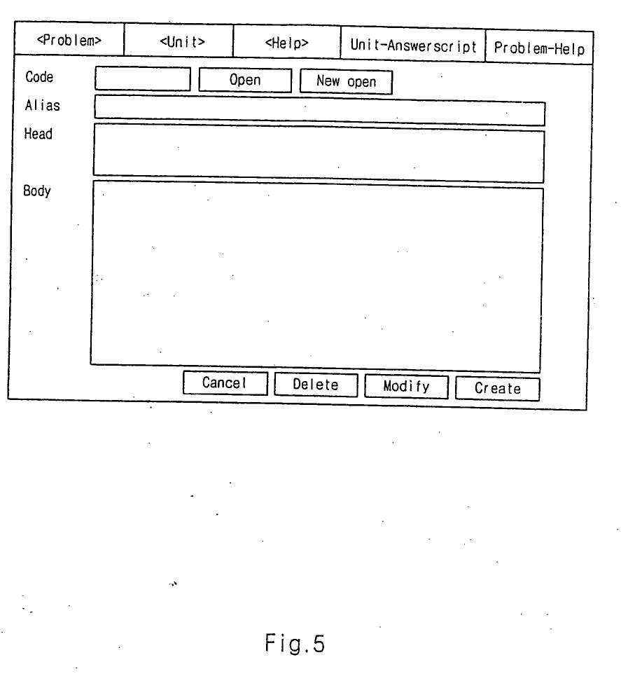

Property of <Help>: configured on an interface screen of FIG. 5.

“Code”: an identifier for identifying <Help>

“Alias”: serves as an identifier. a given name so that experts may identify contents easily.

“Head”: title shown to a user

“Body”: text shown to a user

In an embodiment of the present invention, the grammar is defined as { } and << >> to prepare a specific property of each object and a script thereof.

The { } grammar is presented as {[A] B}. If the {[A] B} satisfies a condition A, B is presented, or unless the {[A] B} satisfies the condition A, B is not presented.

In other words, if {[#Q1234Q#=1] OK} is presented by the { } grammar, a value of #Q1234Q# is “1” (when a user selects 1 on a question corresponding to #Q1234Q#), “OK” is shown on the screen.

The << >> grammar is presented as <<A>> which represents a result of calculation of A. In other words, if <<#Q120Q#+#Q150#>> is presented by the << >> grammar a user inputs “200” as an answer of <Problem> #Q120# and “300” as an answer of <Problem>#Q150Q#, an answer result shown to the user is presented as “500”.

Contents of the consulting system using network can be made by using the above-described objects.

In embodiment of the present invention, the above objects, which an expert defines by using the making module 16, and properties of each object are stored in the database system 12. The service component 10 provides service to a user through the network 5 by utilizing data stored in the database system 12.

In the consulting system using network, if a user who wants use of the service connects with the service component 10, the service component 10 obtains information on basic data and fields of questions of a user and provides the questions and answers to the user consecutively. Here, the user should select corresponding contents shown for subsequent questions and answers or input necessary text, figures or date.

As a result, the service component 10 performs a process of a plurality of questions and answers, defines personalized final answers suitable for the user, and the provides final answers of the consulting module 12 to the user.

Contents of the consulting system using network are embodied by making tools having interface screens as shown in FIGS. 3. to 7. Referring to FIGS. 3 to 7, tools for making the consulting system using network are described.

FIG. 3 shows an interface screen for generating <Problem>. FIG. 4 shows an interface screen for generating <Unit>. FIG. 5 shows an interface screen for generating <Help>.

On the interface screens of FIGS. 3 to 5 are included elements for setting properties corresponding objects to be generated and buttons for performing specific functions.

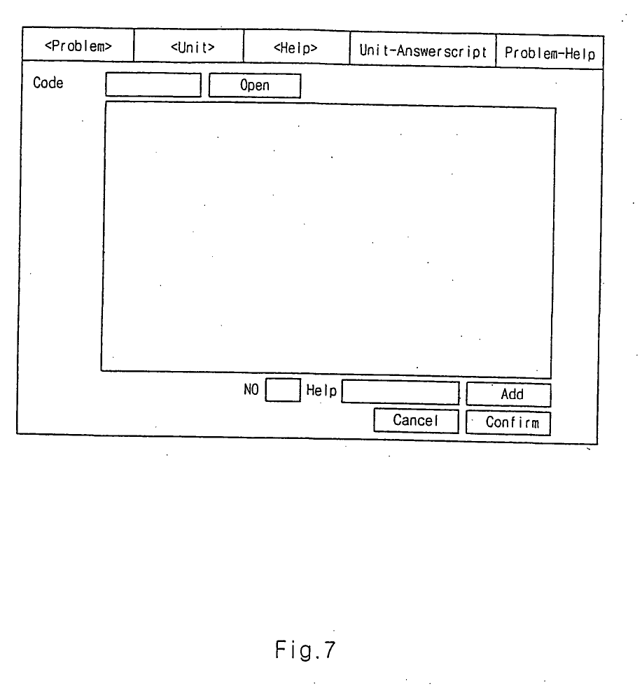

Additional interface screens, which are used in generation of objects, may be comprised. For example, there are provided an interface screen for preparing “Answer script” to <Unit> as shown in FIG. 6, an interface screen for registering <Help> generated in <Problem> as shown in FIG. 7, generated <Units>, an interface screen (Show) where a user can view generated <Unit>, <Problem> and <Help>, an interface screen (Search) where a user can search the generated <Unit>, <Problem> and <Help> under conditions of properties, and an interface screen (Simulation) where the generated <Unit> may be performed as a type used by a user. On each interface screen are included buttons for embodying corresponding functions and elements used in setting.

A method for generating objects and obtaining final answers according to the present invention using the above interface screens is described referring to an example of a law field of Table 2.

TABLE 2
Q1. Is a defect in the product that you ordered ‘hidden defect’?

| | |
|---|---|
| (1) Yes | (2) No |

<Help> If the defect is intended as hidden defect?
If the defect is intended as hidden defect, you did not recognize the exis-
tence of the defect when you ordered the product, and there should be no
error in that you did not know the defect. If the defect is objectively
recognized by anyone although you did not know the defect, the defect is
not a hidden defect.
Q2. Does the product sale between you and a seller correspond to sales
between traders?

| | |
|---|---|
| (1) Yes | (2) No |

Q3. Did you notify the seller that the product has a defect after checking
defects without delay upon receiving the product?

| | |
|---|---|
| (1) Yes | (2) No |

Q4. Can you prove that the seller sent the product to you although
having recognized that the product has a defect?

| | |
|---|---|
| (1) Yes | (2) No |

Q5. Does the defect of the product that you have received make it
impossible not to achieve the object of the contract (order)?

| | |
|---|---|
| (1) Yes | (2) No |

The above example is embodied as one <Unit>. The <Unit> includes Q1, Q2, Q3, Q4 and Q5 as <Problem>. <Help> is set in <Problem> Q1.

“Code” and “Alias” are given to each <Problem> and <Unit> as shown in the following Table 3.

TABLE 3

| Classification | Code | Alias |
|---|---|---|
| Q1 | #Q1967Q# | Hidden defect? |
| Q2 | #Q1969Q# | Sales between traders? |
| Q3 | #Q1971Q# | Notice of defects? |
| Q4 | #Q1972Q# | Ill-will of sellers? |
| Q5 | #Q1973Q# | Achievement of contract object? |
| Unit | #U437U# | Hidden defect of the product? |
| Help | #H184H# | Hidden defect |

As shown in Table 3, after “Code” and “Alias” of objects are determined, <Problems> Q1, Q2, Q3, Q4 and Q5, <Unit> and <Help> may be consecutively generated by an expert using corresponding interface screens.

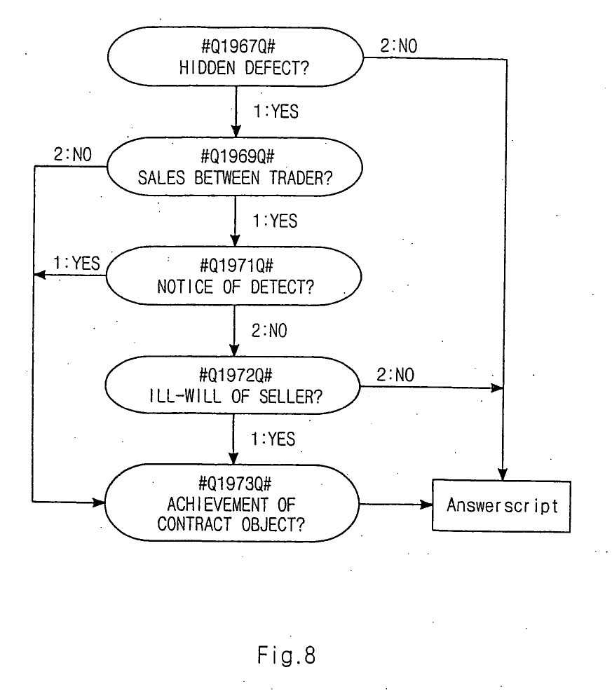

The example of Table 2 proceeds according to the sequence shown in FIG. 8. Final answers are provided by “Answer script”.

Hereinafter, a method for generating <Problem> is described.

Making Q1

When a new <Problem> Q1 is made, a user selects a “New Open” button and subscribes “Code” and “Alias” on <Problem> Q1 of Table 3 to open a new <Problem> Q1. When “Code” and “Alias” are previously given to generate a <Problem> Q1, a user selects an “Open” button to open a new <Problem> Q1.

Here, a function may be set on an interface screen so that “Code” may be automatically generated and given without reference to Table 3.

When the <Problem> Q1 is opened, “Type” is designated. As shown in the example of Table 2, Q1 is a type where a user selects one of two answers. As a result, “Type” is set as “1 of many”, and the number of “Answer” is designated as a variable 2.

When the above “Code”, “Alias” and “Type” are designated, the initial environment setting where <Problem> is made is completed.

Thereafter, a “Begin” button is selected for detail setting.

Since there is no condition for performing the <Problem> Q1, “Condition” is not set.

Then, the sentence “Is a defect in the product that you ordered ‘hidden defect’?” which is given to a user is inputted in “Question”.

Contents that a user refers to are inputted in “Comment”. If unnecessary, the contents are not inputted.

In “Answer”, “(1) Yes, (2) No” are consecutively inputted.

“Main comment” or “Comment” is added to “Answer”. Here, explanation which helps a user to select the whole “Answer” or explanation corresponding to specific answers “Yes” or “No” may be inputted.

A user who will use contents can view contents set in “Question” and “Answer”, and selects an appropriate answer according to the contents.

In “Reference”, a rule on which preparation of the <Problem> Q1 is based (e.g. “Civil Act 570”) is described. “Reference” is used for search to correct or delete contents related to revision and nullification of law.

In “Authors comment”, an expert freely subscribes contents helpful for future work.

After the contents corresponding to properties are set and subscribed, a user selects a “Create” button. Then, <Problem> Q1, #Q1967Q# is generated.

The interface screen of FIG. 3 includes a “Cancel” button where a user may cancel set or subscribed contents, a “Delete” button where <Problem> Q1 may be deleted, and a “Modify” button where a user can correct the set and subscribed contents.

It is necessary that requisites on “hidden defect” regarding <Problem Q1> are notified to a user. For this process, <Help> is registered in a corresponding <Problem>. In order to register <Help>, a “Register Help” button is selected, and then previously prepared <Help> is selected.

If there is no previously prepared <Help>, the screen of FIG. 5 is opened to generate <Help> to be registered.

When a new <Help> is made, a user selects a “New Open” button, and subscribes “Code” and “Alias” on <Help> of Table 3. Here, a function may be set on an interface screen so that “Code” nay be automatically generated and given without reference to Table 3.

In Table 2, the sentence “If the defect is intended as hidden defect?” is described in “Head”, and the sentences “If the defect is intended as hidden defect, you did not recognize the existence of the defect when you ordered the product, and there should be no error in that you did not know the defect. If the defect is objectively recognized by anyone although you did not know the defect, the defect is not a hidden defect.” are described in “Body”. The “Head” and “Body” are contents shown to a user.

After the contents corresponding to properties are set and subscribed, a user selects a “Create” button to generate <Help>.

The “Cancel” button enables a user to cancel the set and subscribed contents on the interface screen of FIG. 5. The “Delete” button helps a user to delete <Help>. The “Modify” button helps a user to correct the set and subscribed contents.

If a user selects a “Register Help” button of <Problem> to be registered after generation of the <Help>, <Help> to <Problem> is registered.

Making Q2

<Problem> Q2 is performed if “(1) Yes” is selected in Q1(#Q1967Q#).

“Code”, “Type” and “Alias” may be set as described in the method of making <Problem> Q1. In Q2, “Condition” is required to be set.

‘#Q1967Q#=1’ is subscribed in “Condition” so that “Condition” may performed if “(1) Yes” is selected in <Problem> Q1 whose “Code” is #Q1967Q#.

The sentence ‘Does the product sale between you and a seller correspond to sales between traders?’ is inputted in “Question” after <Problem>.

The setting of other properties may be set by the same method of <Problem> Q1.

Making Q3 and Q4

<Problems> Q3 and Q4 may be made by defining corresponding properties using the same method of the above-described <Problems> Q1 and Q2.

Making Q5

<Problem> Q5 may comprise three “Conditions”. “Condition” of Q5 is set to be performed if (2) is selected in Q2, (1) is selected in Q3 or (1) is selected in Q4. In other words, if a user selects a corresponding answer in Q2, Q3 and Q4, Q5 is performed. This process where one of three questions is selected corresponds to an “OR” condition of common logic combination.

A conditional statement “#Q1969Q#=2” Or “#Q1971Q#=1” Or “#Q1972Q#=1” is subscribed in “Condition”.

Other properties such as “Answer” are set by the same methods of the above-described Q1 to Q5.

After <Problems> Q1, Q2, Q3, Q4 and Q5 are generated, <Unit> to set the inter-relationship thereof is required.

Making <Unit>

A user selects a “New open” button to generate a new <Unit>, and sets “Code” and “Alias” corresponding to Table 3 as “#U43 U#” and “Hidden defect of the product?”.

Corresponding other properties such as “Title”, “Comment” and “Author comment” are subscribed. Here, <Unit> #U437U# is not set because there is no corresponding contents in “Condition”.

In “Content”, “Codes” corresponding to <Problems> Q1, Q2, Q3, Q4 and Q5 are inputted according to the sequence of <Problems> to be performed.

The sequence of <Problems> registered in “Content” may be changed upward or downward, or deleted by using “Up”, “Down” or “item delete” buttons.

In the <Unit>, <Problems> are performed according to the inputted sequence. Here, the performance of <Problems> included in <Unit> depends on “Condition”.

The <Unit> should provide final answers of other contents according to a selection result of a user. For this process, “Answer script” is set. In an embodiment, “Answer script” corresponding to <Unit> may be generated and registered on the interface screen of FIG. 6.

Table 4 shows an example of “Answer script” for providing final answers.

TABLE 4

| Condition | Final Answer |
|---|---|
| #Q1967Q# = 2 | FA1 |
| #Q1972Q# = 2 | FA2 |
| #Q1973Q# = 1 | FA3 |
| #Q1973Q# = 2 | FA4 |

In the above Table 4, the final answer FA1 means that “It is difficult for you to cancel the contract. Although the product that you have received has a defect, it is not assumed that the defect is a hidden defect”. The final answer FA2 means that “You cannot assert rescission. Although the product that you bought has a hidden defect, the sales contract between you and the seller corresponds to that of traders. You should have check defects of the product upon receiving it without delay. If you recognized a detect, you should have notified the seller of this fact. However, you delayed the notification, and did not prove that the seller recognized the defect.” The final answer FA3 means that “You can return and refund the product. The product that you have ordered has a ‘hidden defect’ stated in Civil Act 570, and makes it impossible to achieve the object of the contract (order). Accordingly, you can demand the responsibility for security on defects from the seller, and cancel the contract. Also, you can demand return and refund of the product for restitution by various methods such as contents-certified mail. The final answer FA4 means that “You cannot cancel the contract. The product that you have received has a defect, and the defect also corresponds to a hidden defect. Accordingly, if the defects cause damages, you can demand the responsibility for security on defects from the seller, and file a claim for damages”.

In Table 2, when #U437U# is performed, the final answers are classified into a selection of #Q1967Q# 2, a selection of #Q1927Q# 2, a selection of #Q1973Q# 1 and a selection of #Q1973Q# 2. As a result, corresponding answers are shown when each condition is satisfied;.

An expert opens the interface screen of FIG. 6 to obtain the above-described answers, inputs ” Codes” of <Unit> where “Answer script” is prepared, and selects an “Open” button.

“Answer script” when #Q1967Q# 2 is selected is defined as “{[#Q1967Q#=2] FA1}”.

An “Insert” button is clicked so that the above contents may be registered as “Answer script” to #Q1967#. Its corresponding content is registered as “Answer script” of#U437U#.

The final answers corresponding to each condition are registered in sequence by the above-described method.

“Answer script” of #U437U# is registered according to the following sequence:

{[#Q1967Q#=2] FA1}

{[#Q1972Q#=2] FA2}

{[#Q1973Q#=1] FA3}

{[#Q1973Q#=2] FA4}

If a “Confirm” button is finally selected, “Answer script” of <Unit> #U437U# is generated.

<Unit> may be defined as “Compulsory condition”.

“Compulsory condition” is what a user designates a previously applied “condition” compulsorily without applying the original “condition” of <Problem> or <Unit>. Since the frequently used <Problem> or <Unit> is used by “Compulsory condition”, reusability is secured.

In order to designate “Compulsory condition”, a user selects a corresponding <Unit>, and then <Problem> to be designated in “Content” of <Unit>.

A number corresponding to <Problem> to be designated as “Compulsory condition” is subscribed in a “No” region set in a lower section. A corresponding condition is inputted in its adjacent “Compulsory condition” region.

“Compulsory condition” designated in a specific <Problem> is cancelled by selecting a “Remove” button having a removal function after selection the corresponding <Problem>.

In other words, “Compulsory condition” is used by changing condition to be suitable for <Unit> to which a user applies a property of <Problem> generated based on a specific <Unit>. Due to use of “Compulsory condition”, other <Problems> which is previously registered to be applied to a specific <Unit> may be used in another <Unit>. As a result, the reusability of <Problem> is secured.

In addition, “Hidden” may be added in the property of <Problem>.

TABLE 5

| | | |
|---|---|---|
| Q1. Confirms to consumer contract? | (1) Yes | (2) No |
| Q2. The purchaser is an individual? | (1) Yes | (2) No |
| Q3. The purchaser is an individual trader? | (1) Yes | (2) No |
| Q4. The seller is a trader? | (1) Yes | (2) No |
| Q5. The seller is an individual trader? | (1) Yes | (2) No |
| Q6. Confirms to consumer contract? | (1) Yes | (2) No |

(1) Yes
{comment} Q1 = 1 or Q4 = 1 or Q5 = 1
(2) No
{comment} Q1 = 2 or Q2 or Q3 = 1 or Q5 = 2

When there are <Problems> as shown in Table 5, suppose that there is <Problem> Q7 which is performed when the contract does not confirm to consumer contract. According to common property of <Problem>, Q7 has a complicated <Condition> wherein Q1=2 or Q2=2 or Q3=1 or Q5=2.

However, if the property of <Problem> Q6 is defined as “Hidden”, <Problem> Q7 has a simple “Condition” of Q6=2. As a result, the “Hidden” property has an effect of the complicated “Condition”. Also, the “Hidden” property may be applied to “Answer script”.

As described above, in an embodiment of the present invention, consulting service according to contents embodied in a consulting system using network may be provided to a user who connects with the service via the network 5 in the service component 10 by using each object.

Experts who have expertise in expert fields may embody algorithm to provide optimum personalized answers to users by configuring the database system 12.

### INDUSTRIAL APPLICABILITY

Accordingly, a consulting system using network may be provided in expert fields via communication network in an embodiment of the present invention. As a result, when a user connects with the consulting system using network, the user can receive personalized answers through an interactive process wherein the user answers questions depending on conditions.

In addition, an expert of a specific field may embody database and algorithm for consultation with generation of objects using formalized tools, and supply contents for providing optimum personalized answers to users depending on rules.

What is claimed is

1. A consulting system using network which provides consulting service of a specific field to a user, said consulting system comprising:
a database system comprising a first object (Problem) having questions given to the user and answers selected by the user, and a second object (Unit) having a series of processes and having answer script for reflecting the process results wherein rules between the objects are defined depending on corresponding property of the objects; and
service component for providing an interface screen for the consulting service to the user via the network, for performing a process where the user answers the:questions supplied by the rules; and for supplying personalized final answers to the user by performing the answer script as the process result.

2. The system according to claim 1, wherein the database system further comprises a third object (Help) for providing questions given to the user corresponding to the first object (Problem) and explanations for selection of the answers of the user, thereby providing corresponding contents during the answer process.

3. The system according to claim 1, further comprising a consulting result processing unit interworking with the service component, said consulting resulting processing unit for backing up consulting results from the service component and for extracting specific data for performing a previously defined subsequent process from the back-up consulting results.

4. The system according to claim 3, wherein the consulting result processing unit transmits the extracted specific data into a predetermined expert using a predetermined method

5. The system according to claim 1, wherein the service component comprises protocol for providing contents to at least one or more equipments selected from personal computer accessible to the network, PDA (Personal Digital Assistant), wireless terminal, wire/wireless telephone set and internet phone.

6. A recording medium for storing a program by using a database system comprising a first object (Problem) having questions given to the user and answers selected by the user, and a second object (Unit) having a series of processes and having answer script for reflecting the process results wherein rules between the objects are defined depending on corresponding property of the objects, said program performed by the following steps comprising:
the first step where questions resulting from the process performed by the rules are provided to the user interfaced via the network and the user answers the questions; and
the second step of providing final answers to the user by performing the answer script as a result of the first step.

7. The medium according to claim 6, wherein the database system further comprises a third object (Help) for providing questions given to the user corresponding to the second object and explanations for selection of the answers of the user, thereby providing explanation defined in the third object to the user corresponding the second object.

8. A content making method to embody a consulting system for providing consulting service of a specific field to a user connected via network, said content making method comprising:
the first step of generating a plurality of first objects (Problem) having properties to set minimum implementation conditions, questions given to the user and answers selected by the user; and
the second step of defining a series of processes including the first object (Problem) with another first object (Problem) and/or another second object (Unit), and of defining answer script for representing final answers given to the user as a result of the process, thereby generating the second object (Unit).

9. The method according to claim 8, wherein as a compulsory condition for applying the first object to the second object is defined as a property of the second object to the implementation condition of the first object, the compulsory condition precedes the implementation condition of the first object during the process of implementing contents set in the second object.

10. The method according to claim 8, wherein a property hidden to the user is provided to the first object (Problem).

11. A recording medium to embody a consulting system for providing consulting service of a specific field to a user connected via network, said recording medium for storing a program performed by the following steps comprising:
the first step of generating a plurality of first objects (Problem) having properties to set minimum implementation conditions, questions given to the user and answers selected by the user; and
the second step of defining a series of processes including the first object (Problem) with another first object (Problem) and/or another second object (Unit), and of defining answer script for representing final answers given to the user as a result of the process, thereby generating the second object (Unit).

12. A consulting system using network wherein a plurality of objects have a rule of interconnection based on conditions, said consulting system comprising:
the first step of providing questions corresponding to a specific object to a user connected via network; and
the second step where the user answers the questions,
wherein a next object is determined depending on the answers, and the first step and the second step are repeatedly performed to embody the interactive consultation with the user.

13. The system according to claim 12, wherein said objects comprise a first object (Problem) having questions given to the user and answers selected by the user, and a second object (Unit) having a series of processes and having answer script for reflecting the process results wherein rules between the objects are defined depending on corresponding property of the objects.
